(19) United States
(12) Patent Application Publication
(10) Pub. No.: US 2020/0407645 A1
(43) Pub. Date: Dec. 31, 2020

(54) ENDOGENOUS ASPHALTENIC ENCAPSULATION OF OIL MATERIALS

(71) Applicant: SOLIDEUM INC., Calgary, Alberta (CA)

(72) Inventors: Ian Donald GATES, Calgary (CA); Jingyi WANG, Calgary (CA)

(73) Assignee: SOLIDEUM INC., Calgary, Alberta (CA)

(21) Appl. No.: 16/975,663

(22) PCT Filed: Feb. 20, 2019
(86) PCT No.: PCT/CA2019/050203

§ 371 Date: Aug. 25, 2020

Related U.S. Application Data
(60) Provisional application No. 62/636,412, filed on Feb. 28, 2018.

(51) Int. Cl. C10C 3/14; C10C 3/00; B29C 43/22; B29C 43/52; C10L 5/36; C10L 5/08

(52) U.S. Cl. CPC C10C 3/14; C10C 3/002; B29C 43/222; C10L 2290/30; C10L 5/363; C10L 5/08; C10L 2250/06; B29C 43/52

(57) ABSTRACT

The invention provides methods for pelletizing oil liquids by inducing endogenous asphaltenes in the liquid to form a resilient external layer on an aliquot of the bituminous liquid.

### FIELD OF THE INVENTION

The invention is in the field of methods for shaping materials, in particular by physically and chemically treating viscous oil and/or heavy oil and/or bituminous liquids to form discrete solid shapes.

### BACKGROUND OF THE INVENTION

Petroleum materials of high viscosity and density are typically grouped into two categories: “heavy oil” and “bitumen” (bitumen is sometimes referred to as extra heavy oil). Heavy oil is often defined as a petroleum that has a mass density between about 920 kg/m³ (or an API gravity of about 26°) and 1,000 kg/m³ (or an API gravity of about 10°) whereas bitumen is petroleum with a mass density greater than about 1,000 kg/m³ (or an API gravity of about 10°) and a viscosity greater than 10,000 centipoise (cP or 10 Pa·s) measured at room temperature and atmospheric pressure, on a gas-free basis. Vacuum residue is a material that is produced from vacuum distillation which at room conditions has typically high viscosities, typically greater than one million cP at room temperature, so that it resembles a solid. Although these terms are used throughout the petroleum industry, references to heavy oil and bitumen and vacuum residue represent categories of convenience and there is a continuum of oils between heavy oil and bitumen. Accordingly, references to heavy oil and/or bitumen herein include the continuum of such substances, and do not imply the existence of some fixed and universally recognized boundary between the two substances. In particular, the term “heavy oil” includes within its scope all “bitumen” including hydrocarbons that are present in semi-solid or solid form such as vacuum residue. Similarly, a “bituminous” material is one that includes a bitumen component, as that component is broadly defined.

Bituminous liquids generally contain asphaltenes. Asphaltenes may for example be suspended as a nanocolloid or otherwise dispersed within a bituminous liquid. Asphaltenes may be defined practically by differential solubility, for example as the component of a bituminous material that is insoluble in n-alkanes, such as n-pentane or n-heptane, but soluble in toluene or benzene or other aromatic solvents. In molecular terms, asphaltenes are generally present as a complex mixture that includes high molecular weight polyaromatic carbon ring units, with oxygen, nitrogen, and sulfur heteroatoms, as well as alkane chains and cyclic alkanes. As used herein, the term “asphaltenes” encompasses this wide range of variously defined materials, and an “asphaltenic” material is one that includes an asphaltene component, as that component is broadly defined.

The presence of asphaltenes in bitumen has in some circumstances been suggested to represent a potential production or transportation problem. During production, for example, asphaltene precipitation and deposition are recognized risks that may result from changes in pressure, temperature, chemical composition and shear rate. In contrast, in some bitumens, relatively high asphaltene concentrations appear to be present as a stable viscoelastic network (Yang and Czarnecki, 2005, Energy & Fuels 19, no. 6: 2455-2459). In the context of transportation, methods have for example been described for removing asphaltenes from bitumen prior to transport (see for example US Patent Publication 20170002275), which may be referred to as partial upgrading of bitumen. For these and other reasons, a wide range of processes are known for removing asphaltenes from petroleum liquids, for example in de-asphalting units in crude oil refineries or bitumen upgraders, such as solvent de-asphalter units that separate the asphaltenes by virtue of the fact that light hydrocarbons, such as propane, butane or pentane, will dissolve aliphatic compounds but not asphaltenes.

The foregoing characteristics of heavy oils and bitumen give rise to a variety of risks and challenges associated with transportation, handling and storage, in liquid form or otherwise. There is accordingly an ongoing need for improved techniques for transporting and handling heavy oil and bitumen.

### SUMMARY OF THE INVENTION

According to a first broad aspect of the present invention, there is provided a method for forming a hydrocarbon pellet, comprising the steps of:
providing a source of hydrocarbon;
transferring an aliquot of hydrocarbon into a mold defining a three-dimensional shape;
heating the aliquot of hydrocarbon inside the at least one mold causing at least the outer surface of the aliquot of hydrocarbon to solidify; and
allowing the hydrocarbon inside the mold to be released from the mold as a pellet essentially shaped according to the shape of the mold.

According to a second broad aspect of the present invention, there is provided a method of segregating a heavy oil or bituminous liquid into discrete shaped solid-like units.

According to a third broad aspect of the present invention, there is provided a method of segregating a mixture of heavy oils and bitumens and other oils, for example, motor oil, spent motor oil, lubricant oils, vegetable oil, spent vegetable oil, tar, pitch, asphalt, and animal fats into discrete shaped solid-like units.

In some exemplary embodiments of the present invention, there is provided a material handling mechanism comprising a patterned belt having recesses therein that hold each shaped aliquot of oil liquid, wherein the patterned belt is heated so as to apply heat to each aliquot and thereby treat the exterior of each shaped aliquot so as to precipitate the outer membrane of asphaltenic material from the shaped bituminous liquid. The heated patterned belt may be maintained at a temperature between about 300° C. and 500° C. Preferably, the heated patterned belt is maintained at between about 350° C. and 450° C.

In exemplary embodiments wherein a patterned belt is employed, an end roll may be used to separate the oil pellets from the patterned belt yielding resiliently shaped units of solid-like oil. The belt may be constructed of an oleicophobic substrate.

In exemplary embodiments wherein a patterned belt is employed, a jet of gas or liquid may be used to cool and remove the oil pellets from the belt at the location of the end roll. In cases wherein a jet of gas is employed, it is preferable that the gas is carbon dioxide or nitrogen. In cases wherein a jet of liquid is employed, it is preferable that the liquid is water.

In some exemplary embodiments of the present invention, the oil applied to the heated belt may be mixed with a solvent which induces the exterior of each shaped aliquot so as to precipitate the outer membrane of asphaltenic material.

The oil in the patterned belt may be exposed to ultrasound. Preferably, the ultrasound frequency is between about 20 and 40 kHz.

It is preferable that the resilient asphaltenic coating formed is less than 2 mm thick.

In some exemplary embodiments of the present invention, during the process of pelletization, light ends from the heavy oil or bitumen that are released are captured as a separate product stream.

An inclined enclosure may be used to collect the light ends by having the light ends condense on the cool surfaces of the enclosure.

In one aspect of the invention, processes are provided that take advantage of the recognition that endogenous asphaltenes in a bituminous liquid may be induced to coalesce or accumulate on the surface of an aliquot or a discrete volume of the bituminous liquid, so as to form a strong solid-like layer that is strong enough to retain the remaining bituminous liquid in the form of a discrete shape. As part of the process, during the conversion of outer surface of the bitumen shape to a solid-like layer, light end oil components are released from the bitumen which are generated from the chemical or physical conversion of the bitumen during the process. Alternatively, the process can yield a solid carbon product where all or nearly all of the bitumen is converted, and the light ends are collected. In effect, endogenous asphaltenes in the bituminous liquid are converted into a resilient solidified surface layer on shaped units of the bituminous liquid. These pellets or capsules of bitumen are then amenable to material handling techniques adapted for particulate solids.

Methods are accordingly provided for segregating a bituminous liquid into discrete shaped units, optionally with the collection of the light end materials. In a continuous process, generally applied to heated bitumen, the bituminous liquid may be divided into shaped liquid aliquots or discrete volumes on a moving belt, each aliquot or volume having a discrete shape defined by a material handling mechanism that contains the aliquot or volume. For example, bitumen can be applied onto a belt with a pattern or indentations on its surface. In another example, the bitumen can be applied to the belt as droplets, for example forming truncated-teardrop shaped aliquots on the surface of the moving belt. The bitumen is heated on the belt to form the solid shapes that are ejected from the belt, for example when the belt rotates around an end roll or when the shapes are scraped from the surface of the belt. The outer surfaces of each shaped aliquot or defined volume is accordingly treated by heat. Heating can be provided by using an induction heating system where focused heating of the volumes of bitumen can be accomplished. Microwave and ultrasonic treatment may also be used to form the outer layer of asphaltenic material from the shaped bituminous liquid. To aid in the production of the outer layer of asphaltenic material on the bitumen volumes, a heated gas can be used. In this way, each shaped aliquot or volume is encapsulated within a resilient asphaltenic coating. The outer asphaltenic layer is sufficiently resilient to retain the discrete shape of the shaped aliquot or volume when the aliquot or volume is released from the material handling mechanism.

The shaped aliquots or volumes may for example be released from the patterned rotating cylinder onto a substrate by using the tight turning radius on a roll together with a cooling gas jet or liquid. The shaped aliquots or volumes released onto the substrate form resiliently shaped units of bituminous liquid encapsulated in the asphaltenic outer membrane, which may for example be cooled on the substrate, and then released from the substrate, for example with a scraper, producing pellets of bituminous liquid.

In another example, the pellets of bituminous liquid can be dropped into a liquid bath or passed through a chilled liquid that reduces the temperature of the pellets yielding a further solidified pellet.

In alternative aspects, the density of the units of bituminous liquid produced by processes of the invention may be adjusted, for example by incorporating agents within the pellets such as gas bubbles, catalysts, or solvents. In some embodiments, pellets can accordingly be designed to be buoyant in water, which may for example facilitate recovery of the pelleted material in the event of an environmental release or spill. In the case where the pellets are less dense than the liquid in the liquid bath, they will float on the surface of the liquid.

### BRIEF DESCRIPTION OF THE DRAWINGS

FIG. 1A is a diagram exemplifying one implementation of the methods described herein for treating a heavy oil or bitumen to a pelletized form. FIG. 1B illustrates an alternative embodiment.

FIG. 2A is a diagram exemplifying another implementation of the methods described herein for treating a heavy oil or bitumen to a pelletized form.

FIG. 2B illustrates an alternative embodiment.

FIG. 3A is a diagram exemplifying another implementation of the methods described herein for treating a heavy oil or bitumen to a pelletized form.

FIG. 3B illustrates an alternative embodiment.

FIG. 4A is a diagram exemplifying another implementation of the methods described herein for treating a heavy oil or bitumen to a pelletized form.

FIG. 4B illustrates an alternative embodiment, adapted for placing heated heavy oil or bitumen on the patterned belt.

FIG. 5A is a diagram illustrating different pellet shapes obtained from a patterned belt to convert heavy oil or bitumen to a pelletized form to gather the light ends generated from the process. FIG. 5B illustrates an alternative embodiment, adapted for placing heated heavy oil or bitumen on the patterned belt and for heating the heavy oil or bitumen by using heated gas and a condensation system for collecting the light ends obtained from the process.

FIG. 5C illustrates an alternative embodiment, adapted for placing droplets of heated heavy oil or bitumen on the belt and for heating the heavy oil or bitumen by using heated gas and a condensation system for collecting the light ends obtained from the process.

FIG. 6 is a diagram illustrating another embodiment of the invention taught here illustrating the capture of the lights ends.

FIG. 7 is a diagram illustrating another embodiment of the invention taught here illustrating the capture of the lights ends.

FIG. 8 is a diagram displaying examples of various shapes that can be form by this process.

FIG. 9 displays two images illustrating a spherical and cubical bitumen pellet.

FIG. 10 is a table listing the properties of the bitumen and pellet skin.

### DETAILED DESCRIPTION OF THE INVENTION

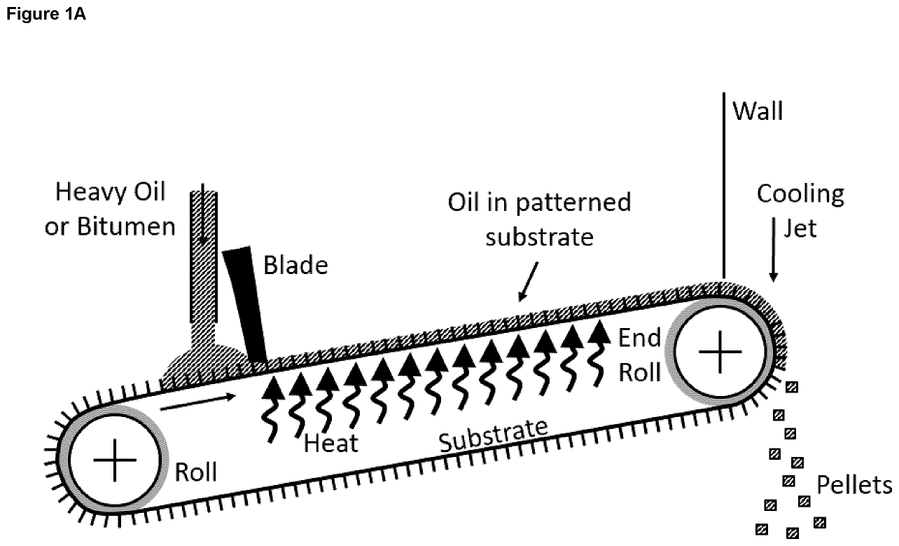

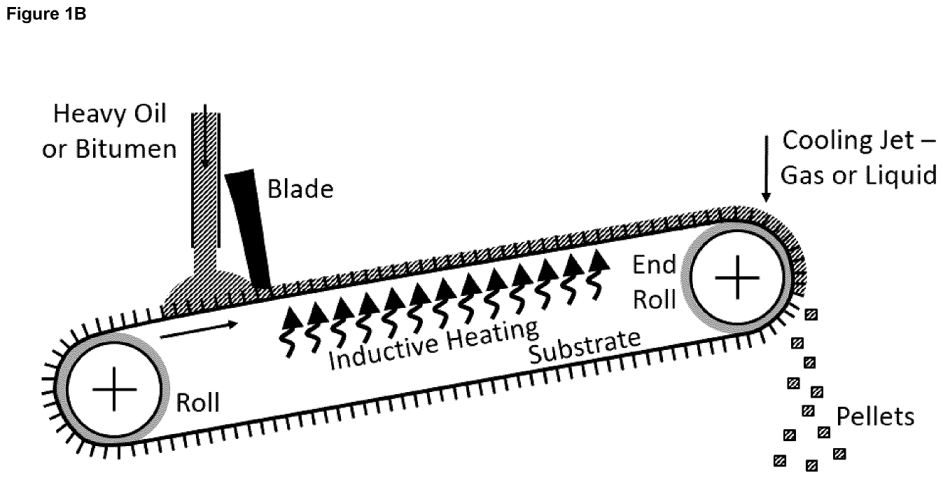

Methods are provided to pelletize a wide variety of heavy oils and bitumen and vacuum residue, including for example residual oil fractions from upgrading and refining plants. In some implementations, continuous high speed methods are provided, as illustrated in FIGS. 1 to 6. Units or pellets of bituminous material may be produced of widely variable size and density.

Methods are described to pelletize mixtures of heavy oils and bitumens and other oils, for example, motor oil, spent motor oil, lubricant oils, vegetable oil, spent vegetable oil, tar, pitch, asphalt, and animal fats. Accordingly, references to oil herein include the continuum of such substances.

In select methods, a layer of heated oil is coated as a layer into the patterns or indentations on a moving heated belt. A blade may be used to make sure that the oil is placed within the pattern and does not sit above the pattern geometry. The belt is continuously heated. The belt is long enough so that the oil in the patterns are converted chemically or physically to a solid layer on the outer edges of the oil liquid that sits in the pattern. Heating can be provided by using heating from below the belt and through the belt, for example from induction heating. Heating can also be provided from above the layer from heated gas injection into the area above the coated layer of oil. More rolls are placed below the belt to support it. The belt then rotates around an end roll wherein the oil pellets are delaminated from the belt and are collected as pellets. A gas or water jet can be used on the end roll to separate the pellets from the belt. In select embodiments, the dimensions of the pellets can for example range from millimeters to tens of centimeters, with some preferred size embodiments being on the order of a few centimeters.

FIGS. 1A and 1B illustrate implementations of the present methods for treating a heavy oil or bitumen or oil mixture. In this method, the oil is heated and flows from a delivery device to the patterned belt, which can be heated by using inductive heating. The oil is then forced into the patterns on the belt by using a blade which limits the thickness of the oil deposited on the belt to the height of the patterns. Prior to being placed on the belt, the oil is heated so that the viscosity of the oil drops to facilitate processing on the patterned belt. In select embodiments, the temperature range for this heating may for example be between about 150° C. and 250° C. In select embodiments, at this stage, the temperature may be constrained to under about 250° C., to minimize reactions from occurring in the heavy oil or bitumen. The heat can for example be delivered through a variety of methods, including heat tracing tape, steam heating, and electrical heating.

As illustrated in FIGS. 1A and 1B, the patterns in the heated belt is filled with hot oil. The heated belt may for example be maintained at between about 300° C. and 500° C., most preferably between 350° C. and 450° C., for example using by using inductive heating.

The surface of the patterned belt may for example be constructed of a oleicophobic material. The oil in the recessed patterns on the belt may then be deposited on an oleicophobic substrate. The oil patterns on the belt substrate are then cooled and promoted off the belt substrate for subsequent transport or processing by using a roll and jet either of gas, for example air or nitrogen, or liquid, for example water. The mechanism may be adapted so that reactions on the outer surface of the bitumen pellet occur on the belt. In this way, the heat of the patterned belt cause reactions that lead to the formation of a thin solid layer on the surface of the bitumen pellet. For example, thermal cracking (pyrolysis) reactions may occur which produce a viscous coating on the surface of the pellets, and asphaltene precipitation may also occur in a way which helps to strengthen the coating on the surface of the pellet.

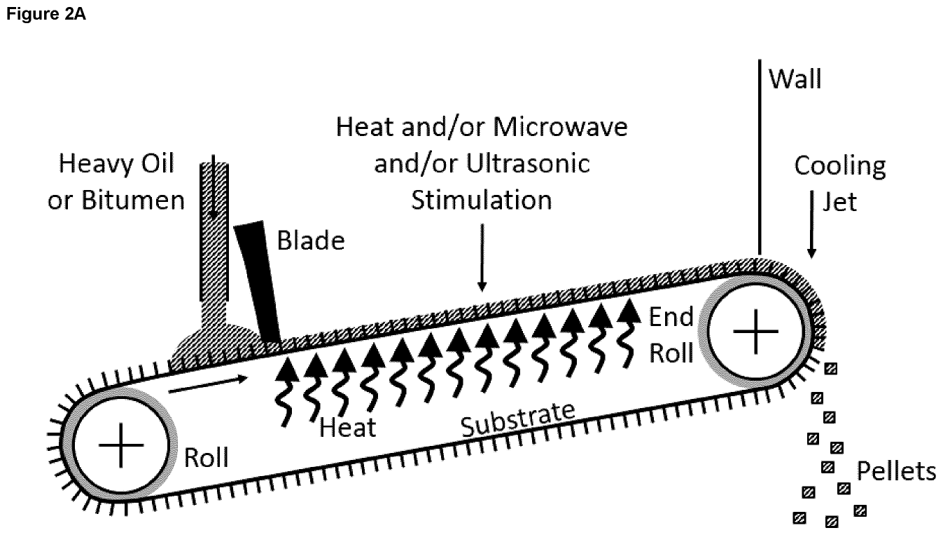

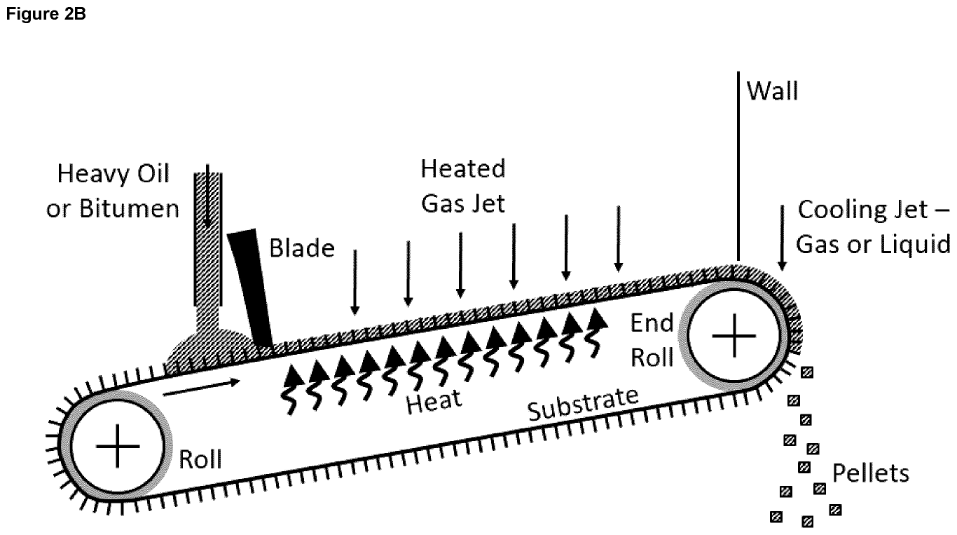

FIGS. 2A and 2B illustrate exemplary embodiments where the controlled material handling environment may for example include mechanisms for applying additional surface treatments to the pellets, for example by treating the exterior of the pellets with chemical agents and/or ultrasonic and/or microwave stimulation and/or a heated gas, for example between 100 and 500° C. or between 350 and 450° C., flowing over the surface of the layer of oil in the patterned belt. These additional surface treatments may for example be applied so as to improve a desired quality of the outer coating. For example, the bituminous liquid may be exposed to chemical agents such as CO₂, propane, pentane or heptane. In addition, physical treatments in addition to heating may be applied, such as ultrasound and/or microwave. Alternatively, the surface treatment may be with a gas that includes air, nitrogen, CO₂, or methane or mixtures thereof. In the case of bitumen, it is optional to use an inert gas without oxygen so no oxidation reactions occur on the top surface of the layer of oil on the patterned belt. In the case of vacuum residue, the gas may optionally be air or other gases.

To form the coating on the outside of the oil pellets, the chemical or physical changes that occur on the outside of the heavy oil or bitumen pellet may for example include asphaltene precipitation and thermal cracking (pyrolysis-splitting larger hydrocarbon chains into smaller-chained compounds). In particular, prior to being coated on the belt, a solvent may be introduced to increase the formation of asphaltene on the surface of the pellets.

Ultrasonic stimulation may for example be carried out so as to cause sonochemical reactions to occur, for example reactions that lead to viscosification of the bitumen. In select embodiments, the frequency of operation of the ultrasonic stimulation may for example be between about 20 and 40 kHz.

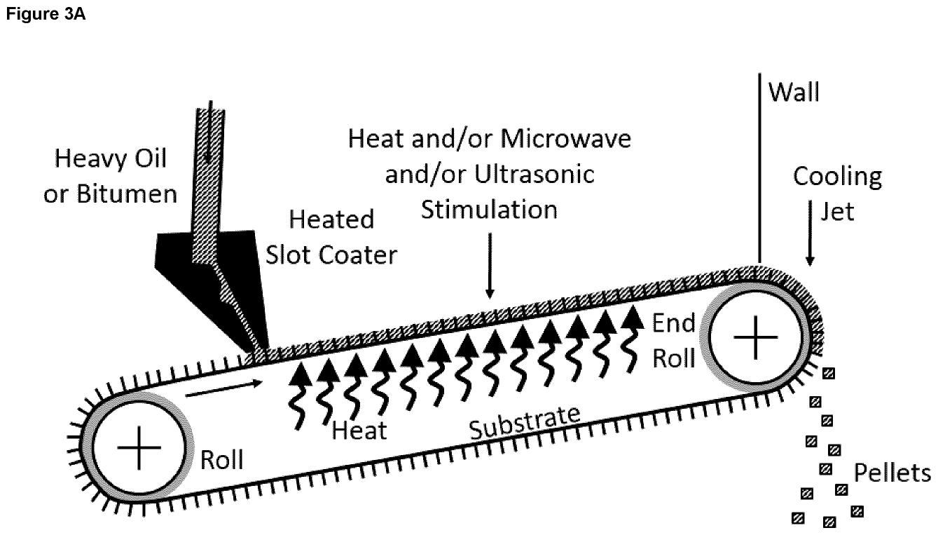

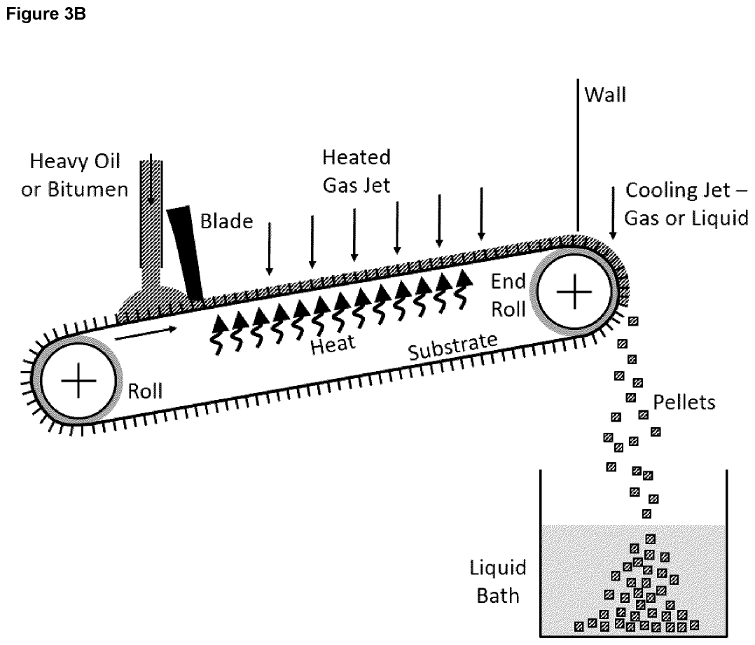

FIGS. 3A and 3B illustrate other exemplary embodiments. In FIG. 3A a slot coating device is used to coat the oil on the heated belt. In FIG. 3B, the pellets are cooled after removal from the belt by using a liquid bath. The bath may be chilled to lower the temperature of the pellets to lower than 40° C., preferably below 20° C. Subsequently, the pellets are collected for further processing or sale.

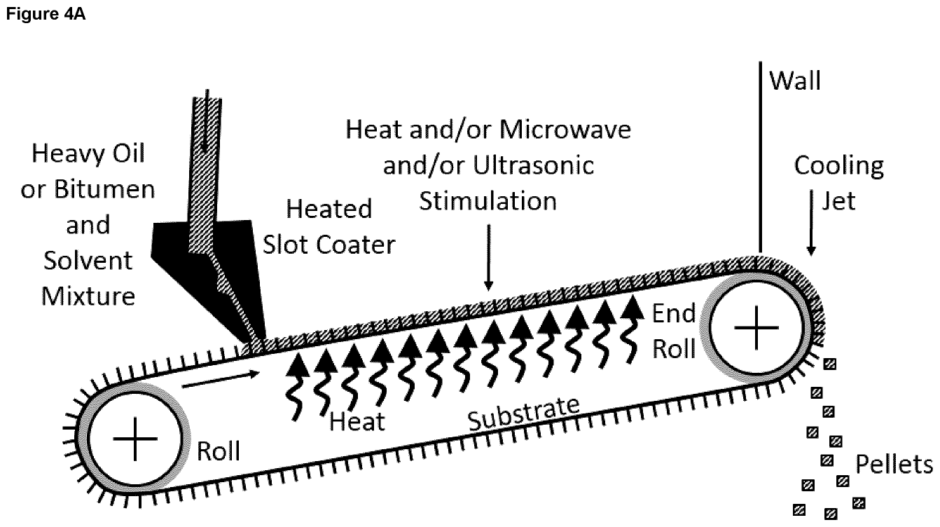

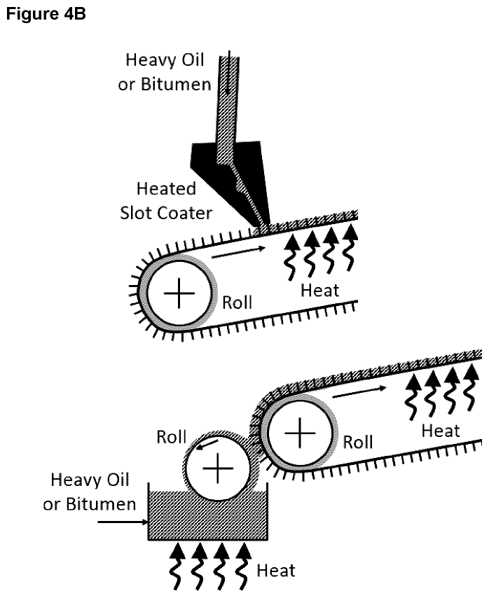

FIG. 4A displays another embodiment of the method where a slot coating device is used to coat the oil on the heated belt and additional heat is provided by using ultrasound and/or microwave stimulation. FIG. 4B displays other embodiments of the method to coat the layer of oil on the patterned belt including a slot coating device or a roll coating device.

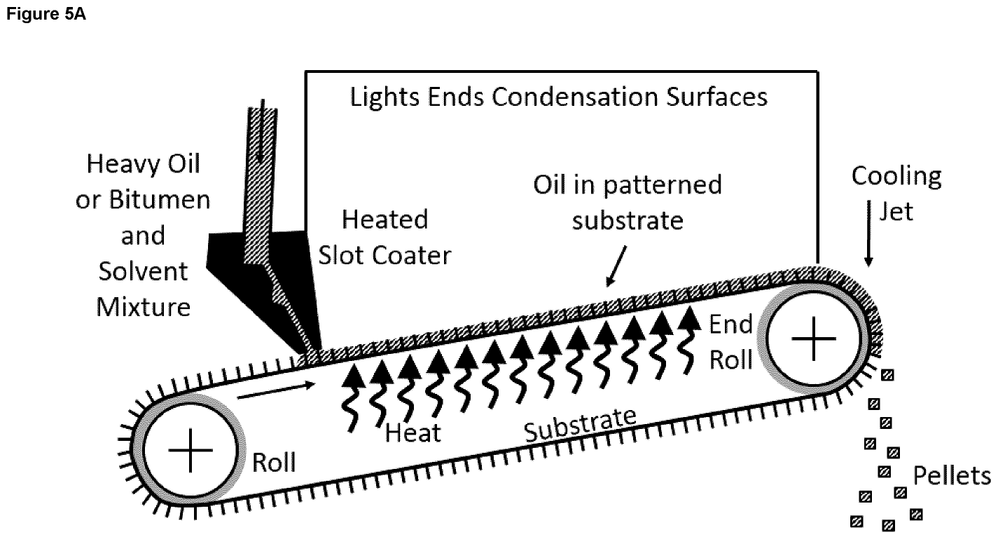

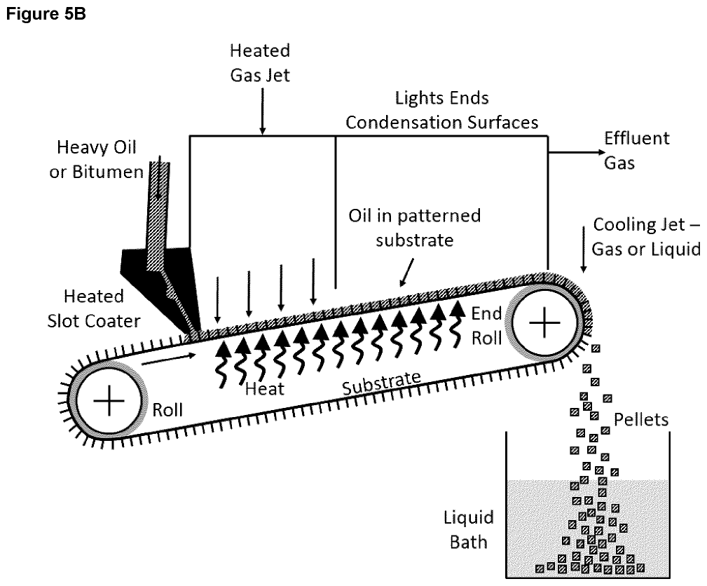

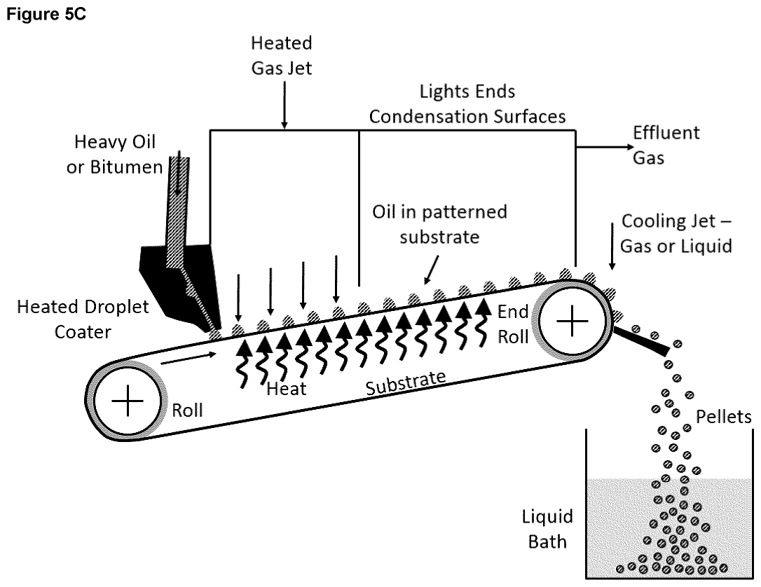

FIG. 5A shows another exemplary embodiment, in which the region of the belt downstream of the oil applicator is contained with cool surfaces to condense the lights ends that are generated from the reactions that generate the solid-like layer on the outer surfaces of the pellet. FIG. 5B shows another exemplary embodiment where there is a region downstream of the oil applicator where heated gas is introduced to heat the top surface of the coated layer of oil to between 100 and 500° C. and preferably between 350 and 450° C. and a second region downstream of the heated gas zone which is contained with cool surfaces to condense the lights ends that are generated from the reactions that generate the solid-like layer on the outer surfaces of the pellet. Process conditions may be selected in such embodiments so as to further cause the precipitation of asphaltenes on the outer surface of the oil pellet, as the pellet of oil liquid is retained in the pattern. FIG. 5C illustrates another exemplary embodiment where individual droplets of oil are placed on the heated belt which undergo the reactions to produce a pellet of oil which are scraped from the belt by using a scraper or air jet or liquid jet. The pellets are subsequently cooled further in a liquid bath. The bath may be chilled to lower the temperature of the pellets to lower than 40° C., preferably below 20° C. Subsequently, the pellets are collected for further processing or sales.

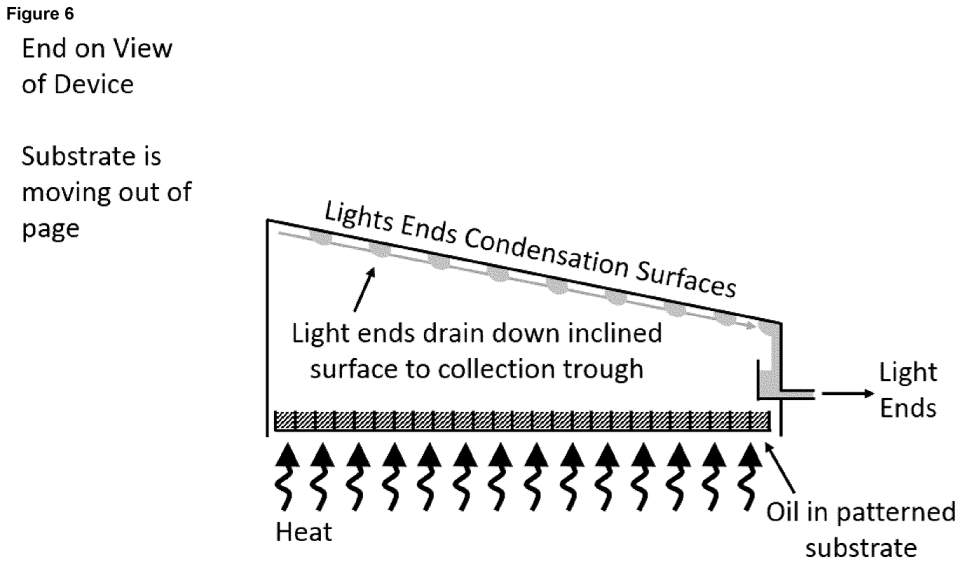

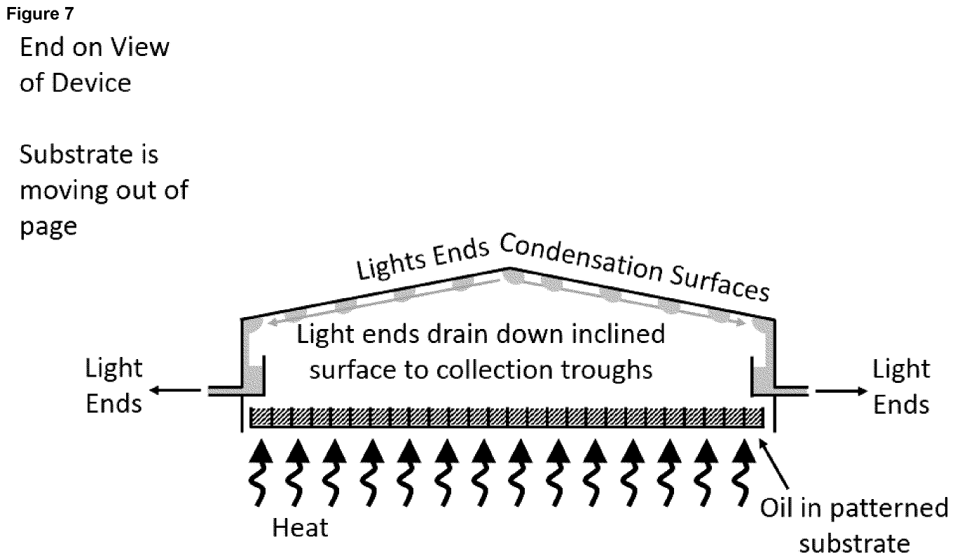

FIGS. 6 and 7 illustrates an embodiment illustrating the light ends collection system where the light ends in vapour phase generated from the oil pellets within the patterned belt condense on a cool solid surface that is inclined where the condensed liquid light ends flows down to be collected and directed from the device.

As illustrated in FIGS. 1 to 7, in select embodiments, downstream of the patterned belt apparatus, the pellets may be cooled, for example to ambient or chilled conditions. In this way, after the pellets emerge from the unit, the pellets are cooled so as to facilitate separation of the pellets from the backing web (substrate).

In some embodiments, prior to the patterned belt apparatus, the oil may be mixed with other materials to yield a pellet with other functional capabilities. For example, the oil can be partially foamed so that it has a gas within the liquid which alters the overall density of the oil yielding pellets that float on water. For example, as illustrated in FIGS. 1A and 1B, the oil can be foamed before it enters the patterns on the belt so that it forms a foamed pellet. The gas used to create the foam can for example be nitrogen or carbon dioxide. The amount of gas in the pellets can be controlled to control the overall density of the bitumen pellets. In another implementation of the method, encapsulated solvent can be added to the heavy oil or bitumen yielding a pellet that contains solvent which when the pellet is processed can be used as part of the product. Similarly, in a further alternative implementation, one or more catalysts can be distributed within the oil pellets, for example to facilitate future processing of the oil pellet.

In alternative embodiments, the processing time and conditions in the patterned belt apparatus can be altered to provide a thicker coating on the pellets. In this manner, the overall chemical composition of the pellet can be tuned to a specific need. For example, the asphaltene content can be raised so that the pellets are more amenable for asphalt processing for road construction.

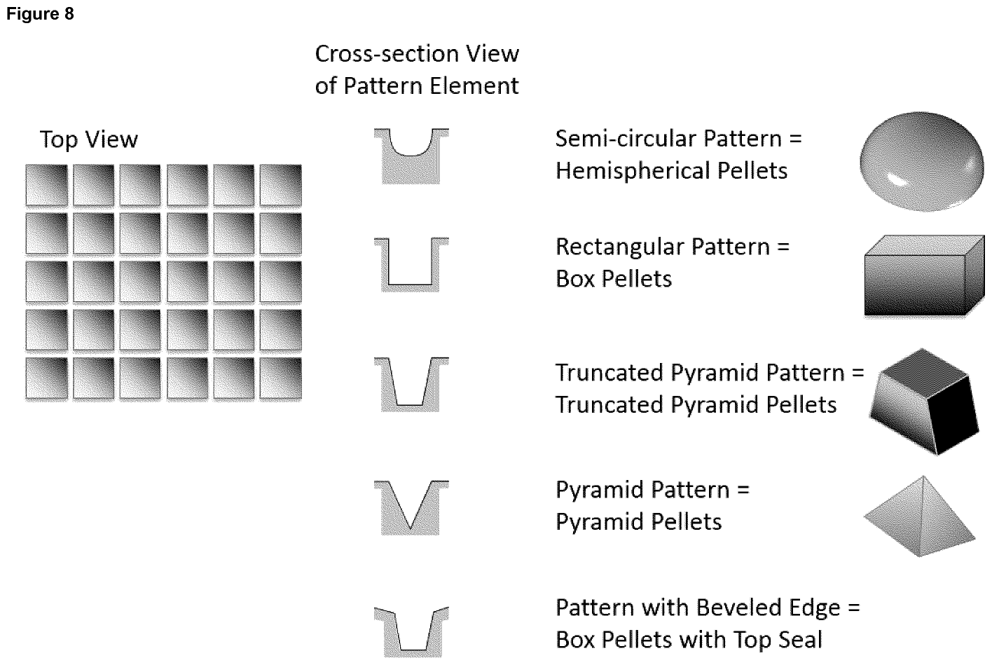

FIG. 8 shows examples of pattern shapes that can be used on the belt.

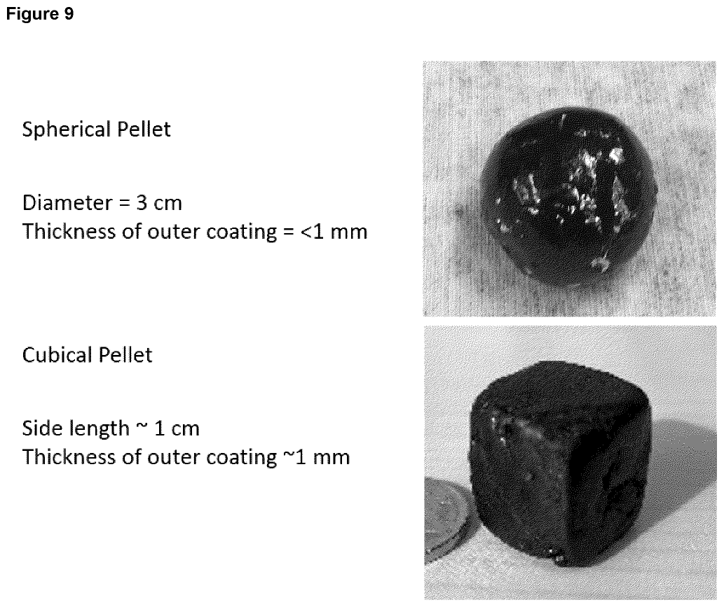

FIG. 9 displays examples of pellets created by using one of the methods described herein. The first image of FIG. 9 displays a spherical oil pellet. The second image of FIG. 9 displays a cubical oil pellet.

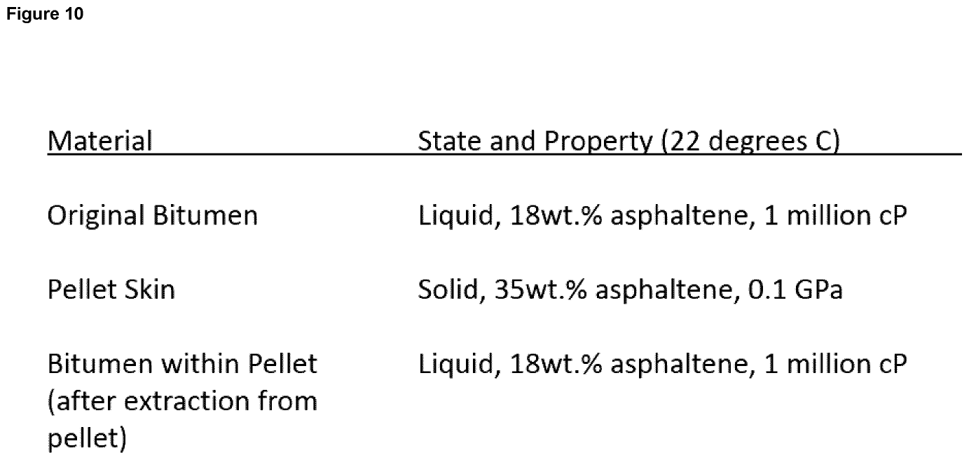

FIG. 10 sets out data from analysis of the interior bitumen and external skin of an exemplary bitumen pellet. The original bitumen is a liquid with viscosity of about 1 million cP. After the process, the outer skin is a solid and has a Young's modulus equal to 0.1 GPa. The asphaltene content of the original bitumen and skin are 18 and 35 weight percent, respectively. The encapsulated bitumen within the pellet has essentially the same properties as that of the original bitumen. The data shows that the skin is relatively thin and rigid.

In alternative implementations of the methods described herein, the oil pellets can be coated, for example with solid asphaltene or coke or polymers. This coating may for example be applied so as to reinforce the mechanical properties of the pellets.

In another implementation, during the formation of the skin on the pellet, light ends from the heavy oil or bitumen may be released and subsequently captured as a separate product stream.

Although various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way. Numeric ranges are inclusive of the numbers defining the range. The word “comprising” is used herein as an open-ended term, substantially equivalent to the phrase “including, but not limited to”, and the word “comprises” has a corresponding meaning. As used herein, the singular forms “a”, “an” and “the” include plural referents unless the context clearly dictates otherwise. Thus, for example, reference to “a thing” includes more than one such thing. Citation of references herein is not an admission that such references are prior art to the present invention. Any priority document(s) and all publications, including but not limited to patents and patent applications, cited in this specification are incorporated herein by reference as if each individual publication were specifically and individually indicated to be incorporated by reference herein and as though fully set forth herein. The invention includes all embodiments and variations substantially as hereinbefore described and with reference to the examples and drawings.

1. A method of segregating a bituminous liquid into discrete shaped units, comprising:
continuously dividing the bituminous liquid into shaped liquid aliquots, each aliquot having a discrete volume defined by a material handing mechanism that dispenses the aliquot into the defined volume;
treating the exterior of each shaped aliquot so as to precipitate an outer membrane of asphaltenic material from the dispensed bituminous liquid, so as to encapsulate the aliquot with a resilient asphaltenic coating that retains the discrete volume of the dispensed aliquot when the aliquot is released from the material handling mechanism, to form a resiliently shaped unit of bituminous liquid encapsulated in the asphaltenic outer membrane.

2. The method of claim 1, wherein the initial density of the bituminous liquid is greater than 1 g/cm³, and the density of the resiliently shaped unit of bituminous liquid is less than 1 g/cm³.

3. The method of claim 1 or 2, wherein the material handling mechanism comprises a patterned belt having recesses therein that support each shaped aliquot of bituminous liquid, wherein the patterned belt is heated by inductive heating so as to apply heat to each aliquot and thereby treat the exterior of each shaped aliquot so as to precipitate the outer membrane of asphaltenic material from the shaped bituminous liquid.

4. The method of claim 3, wherein the heated patterned belt is maintained at a temperature between about 300° C. and 500° C.

5. The method of claim 3, wherein the heated patterned belt is maintained at between about 350° C. and 450° C.

6. The method of any one of claim 3, 4 or 5, wherein an end roll continuously deforms the belt to release aliquots from the material handling mechanism.

7. The method of any one of claims 3 to 6, wherein the belt comprises an oleicophobic substrate on surfaces thereof in contact with the dispensed aliquots.

8. The method of claim 7, wherein the resiliently shaped units of bituminous liquid are cooled on the oleicophobic substrate by a jet of cooling gas or liquid.

9. The method of claim 8, wherein the cooling gas is carbon dioxide or nitrogen; or, the cooling liquid is water.

10. The method of any one of claims 1 to 9, wherein treating the exterior of each shaped aliquot so as to precipitate the outer membrane of asphaltenic material comprises exposing the exterior of each aliquot to a heated gas.

11. The method of claim 10, wherein the heated gas comprises air, nitrogen, carbon dioxide, methane, or a mixture thereof.

12. The method of claim 10 or 11, wherein the heated gas is between about 100° C. and 500° C., or between about 350° C. and 450° C.

13. The method of any one of claims 1 to 12, wherein when the aliquot is released from the material handling mechanism the aliquot is cooled by a cooling medium.

14. The method of claim 13, wherein the cooling medium comprises a liquid bath.

15. The method of claim 14, wherein the cooling medium is maintained at temperature lower than about 40° C. or lower than about 20° C.

16. The method of any one of claims 1 to 15, wherein the resilient asphaltenic coating is less than 2 mm thick.

17. The method of any one of claims 1 to 16, wherein the bituminous liquid as an original viscosity of at least 1 million cP.

18. The method of any one of claims 1 to 17, wherein the resilient asphaltenic coating has a Young's modulus of at least 0.1 GPa.

19. The method of any one of claims 1 to 18, wherein the asphaltene content of the bituminous liquid is 15 to 20 weight percent.

20. The method of any one of claims 1 to 19, wherein the asphaltene content of the resilient asphaltenic coating is 30-40 weight percent.

21. The method of any one of claims 1 to 20, wherein during the process of pelletization, a light hydrocarbon fraction is released from the heavy oil or bitumen, and the light hydrocarbon fraction is collected.

22. The method of any one of claims 1 to 20, wherein treating the exterior of each shaped aliquot further comprises generating and collecting a light hydrocarbon fraction of the bituminous liquid.

23. The method of claim 21 or 22, wherein the light hydrocarbon fraction is collected by condensation on a cooled surface.

24. The method of claim 23, wherein the cooled surface is inclined, so that the condensed light hydrocarbon fraction collects by gravity displacement along the cooled surface.

25. The method of any one of claims 21 to 24, wherein a heavy oil product is recovered from the bituminous liquid encapsulated in the asphaltenic outer membrane by mixing the asphaltenic outer membrane with the encapsulated bituminous liquid, to provide a mixed hydrocarbon product, and wherein the light hydrocarbon fraction is recombined with this mixed hydrocarbon product to provide the heavy oil product.

26. The method of claim 25, further comprising grinding the mixed hydrocarbon product.

27. The method of claim 25 or 26, further comprising heating the mixed hydrocarbon product.

28. The method of any one of claims 21 to 24, wherein a heavy oil product is recovered by removing the asphaltenic outer membrane from the bituminous liquid encapsulated in the asphaltenic outer membrane, and wherein the light hydrocarbon fraction is recombined with the heavy oil product.

29. The method of any one of claims 1 to 28, wherein the bituminous liquid comprises one or more of a motor oil, a spent motor oil, a lubricant oil, a vegetable oil, a spent vegetable oil, a tar, a pitch, an asphalt, a vacuum residue, or an animal fat.

30. The method of any one of claims 1 to 29, wherein the material handling mechanism comprises an oil applicator adapted for dispensing the aliquot into the defined volume.

31. The method of claim 30, wherein the oil applicator comprises a coating device.

32. The method of claim 31, wherein the coating device is a blade coater, a slot coater, or a roll coater.
